(19) United States
(12) Patent Application Publication
(10) Pub. No.: US 2024/0340841 A1
(43) Pub. Date: Oct. 10, 2024

(54) METHOD AND APPARATUS FOR TRANSCEIVING UE CAPABILITY INFORMATION RELATED WITH SIDELINK POSITIONING IN WIRELESS COMMUNICATION SYSTEM

(71) Applicant: Samsung Electronics Co., Ltd., Suwon-si (KR)

(72) Inventors: Jeongseok YU, Suwon-si (KR); Hyunjeong KANG, Suwon-si (KR); Taeseop LEE, Suwon-si (KR); June HWANG, Suwon-si (KR)

(21) Appl. No.: 18/619,907

(22) Filed: Mar. 28, 2024

(30) Foreign Application Priority Data
Apr. 5, 2023 (KR) 10-2023-0044844

(51) Int. Cl. H04W 64/00; H04W 8/00; H04W 84/04; H04W 92/18

(52) U.S. Cl. CPC H04W 64/00; H04W 8/005; H04W 84/042; H04W 92/18

(57) ABSTRACT

The disclosure relates to a 5G or 6G communication system to support a data transmission rate higher than before. A method performed by a user equipment (UE) in a wireless communication system is provided. The method includes generating a discovery message including information on at least one role of the first UE for a sidelink positioning, and transmitting, to a second UE associated with the sidelink positioning, the discovery message.

### CROSS-REFERENCE TO RELATED APPLICATION(S)

This application is based on and claims priority under 35 U.S.C. § 119(a) of a Korean patent application number 10-2023-0044844, filed on Apr. 5, 2023, in the Korean Intellectual Property Office, the disclosure of which is incorporated by reference herein in its entirety.

### BACKGROUND

### 1. Field

The disclosure generally relates to a wireless communication system (or a mobile communication system). More particularly, the disclosure relates to a method and apparatus for transmitting sidelink (SL) positioning user equipment (UE) capability information in a wireless communication system (or a mobile communication system).

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. Additionally, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, Layer-2 (L2) pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical (PHY) layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the development of a communication system, various demands for improving a procedure related to sidelink positioning are increasing daily.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for transmitting sidelink (SL) positioning user equipment (UE) capability information in a wireless communication system, so as to efficiently provide a procedure for inter-UE communication in a sidelink positioning procedure.

Additional aspects will be set forth in part in the description which follows and, in part, will be apparent from the description, or may be learned by practice of the presented embodiments.

In accordance with an aspect of the disclosure, a method performed by a first user equipment (UE) in a wireless communication system is provided. The method includes generating a discovery message including information on at least one role of the first UE for a sidelink positioning, and transmitting, to a second UE associated with the sidelink positioning, the discovery message.

In accordance with another aspect of the disclosure, a method performed by a second user equipment (UE) in a wireless communication system is provided. The method includes receiving, from a first UE associated with a sidelink positioning, a discovery message, and identifying information on at least one role of the first UE for the sidelink positioning based on the discovery message.

In accordance with another aspect of the disclosure, a first user equipment (UE) in a wireless communication system is provided. The first UE includes a transceiver; and a controller coupled with the transceiver and configured to: generate a discovery message including information on at least one role of the first UE for a sidelink positioning, and transmit, to a second UE associated with the sidelink positioning, the discovery message.

In accordance with another aspect of the disclosure, a second user equipment (UE) in a wireless communication system is provided. The second UE includes a transceiver; and a controller coupled with the transceiver and configured to: receive, from a first UE associated with a sidelink positioning, a discovery message, and identify information on at least one role of the first UE for the sidelink positioning based on the discovery message.

According to an embodiment of the disclosure, a UE that needs to perform SL positioning may identify a UE that supports a preferred or required SL positioning scheme via a method of receiving or requesting SL positioning UE capability information transmitted from another UE.

Other aspects, advantageous, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a next-generation mobile communication system according to an embodiment of the disclosure;

FIG. 2 illustrates a user plane radio protocol structure of a next-generation mobile communication system according to an embodiment of the disclosure;

FIG. 3 is a diagram illustrating a control plane radio protocol structure of a next generation mobile communication system according to an embodiment of the disclosure;

FIG. 4 is a diagram illustrating the structure of a base station according to an embodiment of the disclosure;

FIG. 5 is a diagram illustrating the structure of a user equipment (UE) according to an embodiment of the disclosure;

FIG. 6 is a diagram illustrating a protocol structure of a UE that supports SL-positioning (SL-POS) according to an embodiment of the disclosure;

FIG. 7 is a flowchart illustrating a discovery process using discovery model A according to an embodiment of the disclosure;

FIG. 8 is a flowchart illustrating a discovery process using discovery model B according to an embodiment of the disclosure; and

FIG. 9 is a flowchart illustrating a process of selecting a UE for performing an SL-POS operation according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Furthermore, the size of each element does not completely reflect the actual size. In the respective drawings, the same or corresponding elements are provided with the same or corresponding reference signs.

The advantages and features of the disclosure and ways to achieve them will be apparent by making reference to embodiments as described below in detail in conjunction with the accompanying drawings. The disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. In describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The following description of embodiments of the disclosure is mainly directed to New Radio (NR) as a radio access network and Packet Core 5G system or 5G Core Network or Next Generation Core (NG Core) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, long term evolution (LTE), or similar systems) may be used for the sake of descriptive convenience. The disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. The disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station.

It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. In an example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. The “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

The disclosure relates to a method and apparatus for transmitting sidelink (SL) positioning user equipment (UE) capability information in a wireless communication system. The disclosure relates to a method and apparatus for transmitting positioning UE capability information for performing sidelink positioning (SL-POS) by at least two UEs that may be inside a base station communication range and/or outside the base station communication range in a 3GPP 5G system.

The disclosure describes a method and procedure in which a UE performs discovery of at least one UE that is inside an inter-UE communication range, in order to perform SL-POS. To this end, a description is provided in association with a method and procedure of including a role of a UE, which includes a target UE, an anchor UE, or the like, UE capability required for performing SL-POS, and additional information transmission in a discovery message, and transmitting the discovery message based on the corresponding information, or a method and procedure of recognizing capability of a UE that performs reception and briefly recognizing whether an SL-POS scheme (method) that satisfies a requirement of an application or a main agent of positioning is supported and the accuracy of SL-POS when SL-POS is performed with the corresponding UE.

According to embodiments of the disclosure, the UE may directly request SL-POS with other UEs via SLs. Based on the information associated with the discovered other UEs, the UE may select at least one UE to perform SL-POS, and may perform SL-POS.

According to other embodiments of the disclosure, the UE may request a network or another UE to perform SL-POS with other UEs. The UE may transmit information associated with the discovered other UEs to a location management function (LMF) and/or a server UE, and the LMF and/or server UE may select at least one UE to perform SL-POS based on the corresponding information and may indicate performing SL-POS. The UE may, for example, use a mobile originated location request (MO-LR) procedure, an SL-POS location request procedure, or a predetermined message (e.g., a discovery report) in order to report a result of discovering another UE that may be used for SL-POS, and an LMF and/or server UE may use a mobile terminated location request (MT-LR), a network induced location request (NI-LR), or an SL-POS location request procedure in order to perform SL-POS of another UE. The LMF and/or server UE may establish a separate LTE positioning protocol (LPP) or sidelink positioning protocol (SLPP) session with each UE, and may exchange an LPP or SLPP message, in order to obtain information associated with a UE that is usable while performing an SL-POS procedure for estimating the location of a target UE. The LMF or server UE may, for example, indicate a discovery operation to the target UE in order to obtain information of other UEs capable of performing SL-POS in the communication range of the UE, and the target UE may perform a discovery operation and may report the result thereof to the LMF or server UE. Based on the information of other UEs in the communication range that is obtained from the UE, the LMF or the server UE may play a role in determining at least one UE involved in performing of SL-POS for estimating the location of the target UE, determining a location estimation scheme, determining a location estimation mode, and determining a specific time and frequency resource for performing SL-POS, the settings of a measurement operation, and the like.

Terms used in the disclosure may be defined as below.
Sidelink positioning (SL-POS): estimating the location of a UE by using an SL-POS reference signal (RS) transmitted via an SL. In this instance, the location of the UE may be absolute location information (absolute positioning), relative location information (relative position), ranging information (e.g., distance/direction information relative to another UE). A ranging operation (estimating distance/direction/relative location between UEs) may be included in the concept of SL-POS.
Target UE: a UE of which the location is to be estimated (e.g., a UE of which the location is capable of being estimated based on a SL).
Anchor UE: a UE capable of supporting location estimation of a target UE (e.g., a UE that transmits or receives a reference signal for estimating the location of a target UE, or a UE that transfers information needed for location estimation to a target UE via an SL).
Located UE: a UE of which the location is known or identifiable via a location estimation scheme including a Uu interface-based location estimation scheme or the like. A located UE may be used for estimating the location of a target UE using SL-POS.
Server UE: a UE including a function of determining a measurement scheme (method), a function of transmitting assistant data and/or calculating a location, and/or a function of calculating an SL-POS location. A server UE may determine an SL-POS measurement method, may transmit assistant data, or may interoperate with another UE via an SL in order to calculate the location of a target UE. A target UE or an anchor UE that supports at least one of those functions may operate as a server UE.
Client UE: a UE that is different from an anchor UE or a target UE may request an SL-POS service, in place of an application of a target UE. A client UE may not be capable of directly performing an SL-POS, but may be capable of transmitting or receiving a service request and a result by using an SL or 5GC in order to communicate with an anchor UE or a target UE.
Assistant UE: a UE that supports an SL-POS operation between an anchor UE and a target UE. In the case in which direct SL-POS between an anchor UE and a target UE is unavailable, the result of SL-POS between the anchor UE and the target UE may be obtained using the result of an SL-POS operation performed between the anchor UE and an assistant UE, and the result of an SL-POS operation performed between the assistant UE and the target UE.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

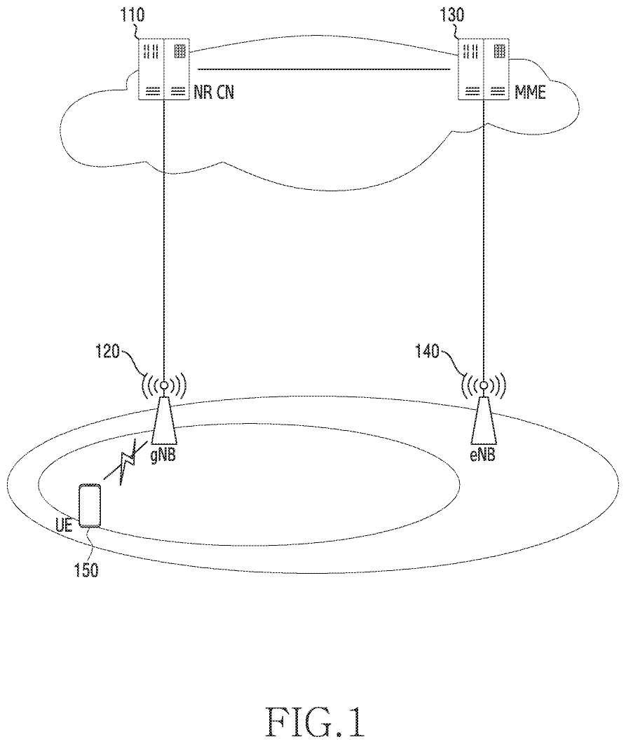

FIG. 1 illustrates a structure of a next-generation mobile communication system according to an embodiment of the disclosure.

Referring to FIG. 1, a radio access network of a next-generation mobile communication system (hereinafter NR or 5G) may include a next-generation base station (next-generation node B, hereinafter NR gNB, gNB, or NR base station) 120, and a new radio core network (NR CN) 110. A user terminal (new radio user equipment, hereinafter NR UE or NR terminal) 150 may access an external network via the NR gNB 120 and the NR CN 110.

In FIG. 1, a NR gNB 120 may correspond to an evolved node B (eNB) 140 of an LTE system. The NR gNB 120 may be connected to the NR UE 150 through a radio channel and provide outstanding services as compared to the eNB 140. In the next-generation mobile communication system, since all user traffic is serviced through a shared channel, a device that collects state information, such as buffer statuses, available transmit power states, and channel states of UEs, and performs scheduling accordingly is required, and the NR gNB 120 may serve as the device. Generally, one NR gNB 120 may control multiple cells. In order to implement ultrahigh-speed data transfer beyond LTE, a wider bandwidth than the maximum bandwidth of LTE may be used, an orthogonal frequency division multiplexing (hereinafter referred to as OFDM) may be employed as a radio access technology, and a beamforming technology may be additionally integrated therewith. Furthermore, an adaptive modulation and coding (AMC) scheme for determining a modulation scheme and a channel coding rate according to a channel state of a UE may be employed. The NR CN 110 may perform functions such as mobility support, bearer configuration, and QoS configuration. The NR CN 110 is a device responsible for various control functions, as well as a mobility management function for a UE, and may be connected to multiple base stations. Additionally, the next-generation mobile communication system may interwork with the existing LTE system, and the NR CN 110 may be connected to a mobility management entity (MME) 130 via a network interface. The MME 130 may be connected to the eNB 140.

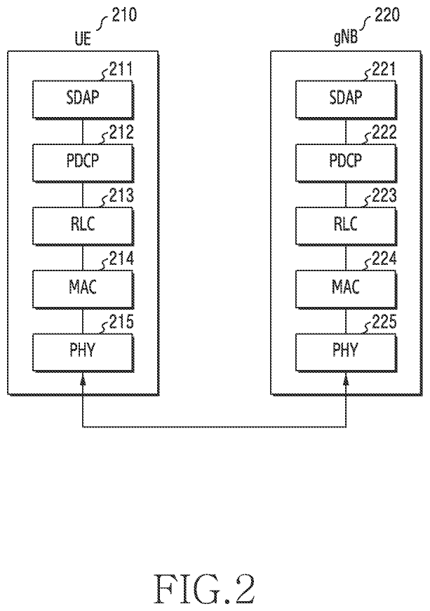

FIG. 2 illustrates a user plane radio protocol structure of a next-generation mobile communication system according to an embodiment of the disclosure.

Referring to FIG. 2, in a UE 210, a user plane radio protocol of a next-generation mobile communication system may consist of a service data adaptation protocol (SDAP) 211, a packet data convergence protocol (PDCP) 212, a radio link control (RLC) 213, a medium access control (MAC) 214, and/or a physical (PHY) 215. In a gNB 220, a user plane radio protocol may consist of an SDAP 221, a PDCP 222, an RLC 223, an MAC 224, and/or a PHY 225. In the disclosure, the expression “may consist of” may be replaced with the expression “may include”. In a UE 210, a user plane radio protocol of a next-generation mobile communication system may include an SDAP 211, a PDCP 212, an RLC 213, an MAC 214, and/or a PHY 215.

Major functions of the SDAPs 211 and 221 may include at least some of the following functions:
Mapping between a quality of service (QoS) flow and a data radio bearer
Marking QoS flow ID (QFI) in both DL and UL packets

Major functions of the PDCPs 212 and 222 may include some of the following functions:
Transfer of data (user plane or control plane)
Maintenance of PDCP sequence numbers (SNs)
   Header compression and decompression using robust header compression (ROHC) protocol
   Header compression and decompression using ethernet header compression (EHC) protocol
Compression and decompression of uplink PDCP service data units (SDUs): DEFLATE based user data compression (UDC) only
Ciphering and deciphering
Integrity protection and integrity verification)
Timer based SDU discard
Routing for split bearers
Duplication
Reordering and in-order delivery
Out-of-order delivery
Duplicate discarding

Major functions of the RLCs 213 and 223 may include some of the following functions:
Transfer of upper layer protocol data units (PDUs)
Sequence numbering independent of one in PDCP (unacknowledged mode (UM) and acknowledged mode (AM))
Error correction through automatic repeat request (ARQ) (AM only)
Segmentation (AM and UM) and re-segmentation (AM only) of RLC SDUs
Reassembly of SDU (AM and UM)
Duplicate detection (AM only)
RLC SDU discard (AM and UM)
RLC re-establishment
Protocol error detection (AM only) Major functions of the MACs 214 and 224 may include at least some of the following functions:
Mapping between logical channels and transport channels
Multiplexing of MAC SDUs from one or different logical channels onto transport blocks (TBs) to be delivered to physical layer on transport channels
Demultiplexing of MAC SDUs to one or different logical channels from transport blocks (TBs) delivered from physical layer on transport channels
Scheduling information reporting
Error correction through hybrid automatic repeat request (HARQ)
Logical channel prioritization
Priority handling between overlapping resources of one UE

The PHY layers 215 and 225 may perform channel coding and modulation of upper layer data to generate OFDM symbols and may convert the OFDM symbols into an RF signal and then transmit the same through an antenna. The PHY layers 215 and 225 may perform demodulation and channel decoding of the received OFDM symbols and then transfer the OFDM symbols to an upper layer.

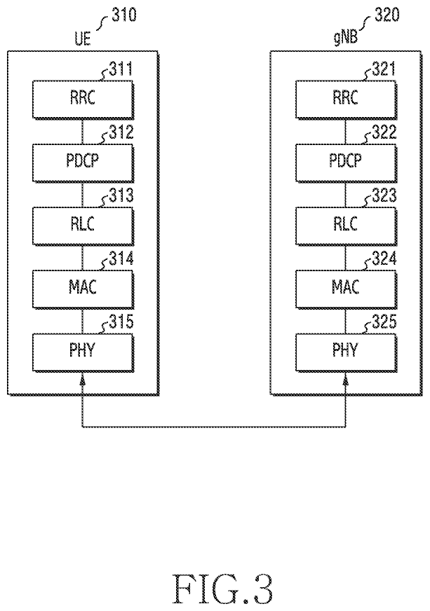

FIG. 3 is a diagram illustrating a control plane radio protocol structure of a next generation mobile communication system according to an embodiment of the disclosure.

Referring to FIG. 3, in a UE 310, a control plane radio protocol of a next generation mobile communication system may include a radio resource control (RRC) 311, a PDCP 312, an RLC 313, a MAC 314, and/or a PHY 315. In a base station 320, a control plane radio protocol may include an RRC 321, a PDCP 322, an RLC 323, a MAC 324, and/or a PHY 325.

The function of the RRC 311 and 321 may include at least some of the following functions.
Broadcasting of system information (broadcast of system information related to access stratum (AS) and non-access stratum (NAS))
Paging (paging initiated by 5GC or NG-RAN)
Establishing and managing an RRC connection between a UE and an NG-RAN, adding, modifying, and releasing carrier aggregation and dual connectivity between NRs or between NR and LTE (establishment, maintenance and release of an RRC connection between the UE and NG-RAN including: addition, modification and release of carrier aggregation; addition, modification and release of dual connectivity in NR or between E-UTRA and NR).
Security function including key management (security functions including key management)
Establishing, configuring, maintaining, and releasing signaling radio bearers and data radio bearers (establishment, configuration, maintenance and release of signaling radio bearers (SRBs) and data radio bearers (DRBs))
Supporting UE mobility (mobility functions including: handover and context transfer; UE cell selection and reselection and control of cell selection and reselection; inter-RAT mobility)
QoS management functions
UE measurement reporting and control of the reporting
Detecting radio link failure and recovering therefrom (detection of and recovery from radio link failure)
NAS message transmission (NAS message transfer to/from NAS from/to UE)

The main functions of PDCP 312 and 322, RLC 313 and 323, MAC 314 and 324, and/or PHY 315 and 325 may be based on the example of FIG. 2.

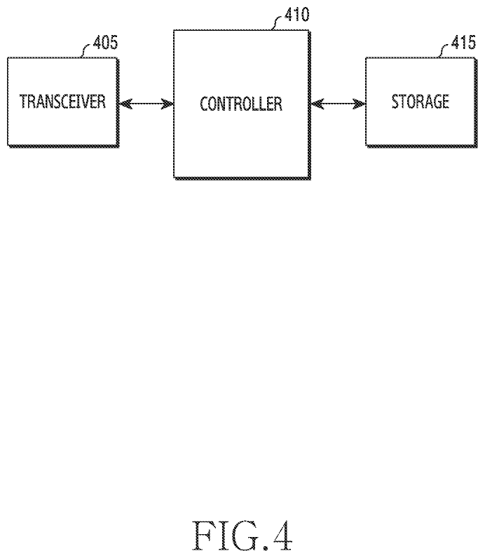

FIG. 4 is a diagram illustrating the structure of a base station according to an embodiment of the disclosure.

Referring to FIG. 4, the base station may include a transceiver 405, a controller 410, and a storage 415. According to the above-described communication method of the base station, the transceiver 405, the controller 410, and the storage 415 may operate. A network device may also correspond to the structure of a base station. The component elements of the base station are not limited to the above-described example. For example, the base station may include more or fewer component elements than the above-described component elements. In another example, the base station may include the transceiver 405 and the controller 410. In addition, the transceiver 405, the controller 410, and the storage 415 may be configured as a single chip.

The transceiver 405 is the collective name for the receiver of the base station and the transmitter of the base station, and may be capable of performing signal transmission or reception with a UE, another base station, or another network device. The signal transmitted or received by the base station may include control information and data. The transceiver 405, for example, may transmit system information to a UE, and may transmit a synchronization signal or a reference signal. To this end, the transceiver 405 may include an RF transmitter that up-converts and amplifies the frequency of a transmitted signal, an RF receiver that low-noise amplifies a received signal and down-converts the frequency of the signal, and the like. This is merely an example of the transceiver 405, and the component elements of the transceiver 405 are not limited to an RF transmitter and an RF receiver. The transceiver 405 may include a wired or wireless transceiver, and may include various configurations for signal transmission or reception. Additionally, the transceiver 405 may receive a signal via a communication channel (e.g., a wireless channel) and output the same to the controller 410, and may transmit a signal output from the controller 410 via a communication channel. The transceiver 405 may receive a communication signal and may output the same to a processor, and may transmit a signal output from the processor to a UE, another base station, or another entity via a wired or wireless network.

The storage 415 may store a program and data needed when the base station operates. In addition, the storage 415 may store control information or data included in a signal obtained by the base station. The storage 415 may be configured as a storage medium such as a read only memory (ROM), a random access memory (RAM), a hard disk, a compact disc read only memory (CD-ROM), a digital versatile disc (DVD), and the like, or a combination of storage media. In addition, the storage 415 may store at least one piece of information among information transmitted or received via the transceiver 405 and information produced by the controller 410.

In the disclosure, the controller 410 may be defined as a circuit, an application-specified integrated circuit, or at least one processor. The processor may include a communication processor (CP) that performs control for communication, and an application processor (AP) that controls a higher layer such as an application program or the like. The controller 410 may, for example, control overall operation of the base station according to the embodiments of the disclosure. The controller 410 may control a signal flow in blocks so that operations based on the above-described flowchart are performed.

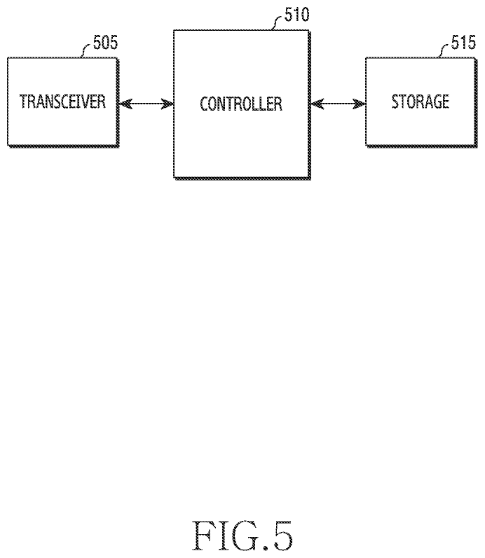

FIG. 5 is a diagram illustrating the structure of a user equipment (UE) according to an embodiment of the disclosure.

Referring to FIG. 5, a UE may include a transceiver 505, a controller 510, and a storage 515. According to the above-described communication method, the transceiver 505, the controller 510, and the storage 515 may operate. The component elements of the UE are not limited to the above-descried example. For example, the UE may include more or fewer component elements than the above-described component elements. For another example, the UE may include the transceiver 505 and the controller 510. In addition, the transceiver 505, the controller 510, and the storage 515 may be configured as a single chip.

The transceiver 505 is the collective name for the receiver of the UE and the transmitter of the UE, and may be capable of performing signal transmission or reception with a base station, another UE, or a network entity. The signal transmitted to or received from the base station may include control information and data. The transceiver 505, for example, may receive system information from a base station, and may receive a synchronization signal or a reference signal. The transceiver 505 may include an RF transmitter that up-converts and amplifies the frequency of a transmitted signal, an RF receiver that low-noise amplifies a received signal and down-converts the frequency of the signal, and the like. This is merely an example of the transceiver 505, and the component elements of the transceiver 505 are not limited to an RF transmitter and an RF receiver. In addition, the transceiver 505 may include a wired and wireless transceiver, and may include various configurations for signal transmission or reception. The transceiver 505 may receive a signal via a wireless channel and output the same to the controller 510, and may transmit a signal output from the controller 510 via a wireless channel. In addition, the transceiver 505 may receive a communication signal and may output the same to a processor, and may transmit a signal output from the processor to a network entity via a wired or wireless network.

The storage 515 may store a program and data needed when the UE operates. In addition, the storage 515 may store control information or data included in a signal obtained by the UE. The storage 515 may be configured as a storage medium such as a ROM, a RAM, a hard disk, a CD-ROM, a DVD, and the like, or a combination of storage media.

In the disclosure, the controller 510 may be defined as a circuit, an application-specified integrated circuit, or at least one processor. The processor may include a communication processor (CP) that performs control for communication, and an application processor (AP) that controls a higher layer such as an application program or the like. The controller 510 may, for example, control overall operation of the UE according to an embodiment of the disclosure. The controller 510 may control a signal flow in blocks so that operations based on the above-described flowchart are performed.

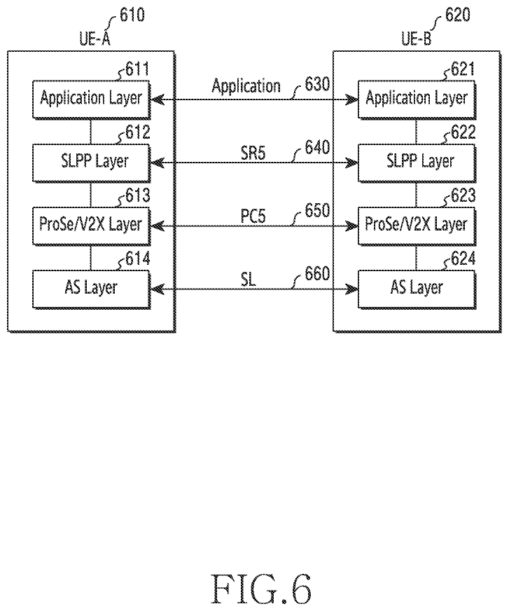

FIG. 6 is a diagram illustrating a protocol structure of a UE that supports SL-POS according to an embodiment of the disclosure.

Referring to FIG. 6, a UE 610 and 620 that supports SL-POS may include an application layer 611 and 621, an SLPP layer 612 and 622, a ProSe/V2X layer 613 and 623, and an AS layer 614 and 624.

The application layer 611 and 621 may be an application that requires location information of the UE 610 and 620, and may perform operations, such as exchanging of location information between different UEs (e.g., between UEs 610 and 620), requesting location information, or the like, via an application interface 630. The application interface 630 may perform communication based on a PC5 650 and 660 interface or a 5G system (e.g., Uu) interface. The application layer 611 and 621 may request the SLPP layer 612 and 622 to obtain location information, in order to obtain the location information of the UE 610 and 620. The application layer 611 and 621 may request, from the SLPP layer 612 and 622, requirements including the type of location information required (e.g., absolute location information, relative location information, ranging information, and the like) and accuracy of the location information required (e.g., an error provided in a predetermined unit in association with location information related to a distance or a range, an error provided in a predetermined unit in association with an angle, or the like).

In the case in which the application layer 611 and 621 or the SLPP layer 622 and 612 of another UE or an LMF requests the SLPP layer 612 and 622 to perform an SL-POS operation, the SLPP layer 612 and 622 may start an SL-POS operation. The SLPP layer 612 and 622 may include at least one of the following three functions, and communication between SLPP layers (e.g., the layers 612 and 622) may be performed based on an SR5 interface 640.
Device and service discovery function (DSDF): performs discovery of other UEs which are in the communication range of a UE, and are capable of performing SL-POS, and provides the identified UEs and services supported by the identified UEs (e.g., capability, an SL-POS method, accuracy, or the like supported by the corresponding UE) to a higher layer.
Group support service function (GSSF): performs group management in the case in which a higher layer requests group management based on communication using a PC5 interface provided by a ProSe layer or V2X layer.
Sidelink positioning and ranging function (SPRF): transmits or receives a control signal (signaling) for management and adjustment between UEs or groups. Messages produced from the SPRF may be transmitted via a PC5 interface and may be regarded as data traffic.

The ProSe/V2X layer 613 and 623 may support functions such as discovery, communication, UE-to-network relay, UE-to-UE relay, and the like by using communication between UEs via the PC5 interface 650. In order to support the functions, it may include functions such as PC5 650 unicast link management, Layer-2 ID management, authorization, policy and parameter list configuration (provisioning), PC5 user plane (PC5-U) data to QoS flow mapping, and the like.

The AS layer 614 and 624 may be configured as shown in the example 211, 212, 213, 214, and 215 of FIG. 2, or may be configured as shown in the example 311, 312, 313, 314, and 315 of FIG. 3. The PC5 interface 650 used for inter-UE communication may be expressed as an SL 660 in a physical layer.

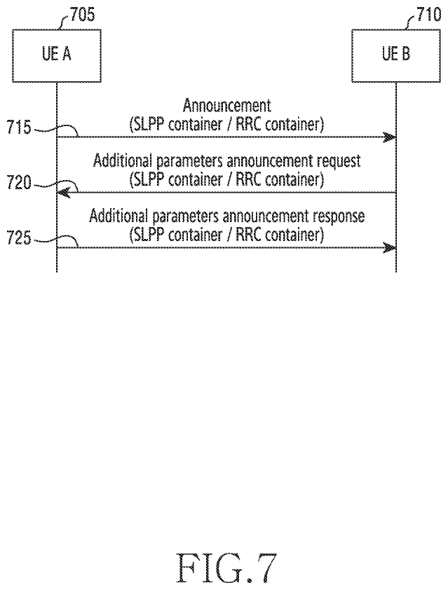

FIG. 7 is a flowchart illustrating a discovery process using discovery model A according to an embodiment of the disclosure.

Referring to FIG. 7, UE A 705 may broadcast a discovery message (e.g., an announcement 715) so as to enable a UE (e.g., UE B 710) that presents in a communication range to discover the UE A 705. The discovery message is not limited to the announcement 715, and may include all messages used for a UE discovery procedure including an additional parameters announcement request 720, an additional parameters announcement response 725, a solicitation, and a response. An application layer of the UE A 705 or an LMF may indicate, to an SLPP layer, starting or stopping transmission of the discovery message 715, and the SLPP layer may indicate, to a ProSe/V2X layer, transmission of the discovery message 715. In an embodiment, the UE B 710 that receives the discovery message 715 may identify the UE A 705 based on information included in the discovery message 715 and a Layer-2 ID for transmitting the discovery message 715. According to another embodiment, at least one piece of information among the following information may be included in the discovery message 715, 720, and 725.
A ProSe identifier indicating SL-POS, in the case of 5G ProSe direct discovery
An application layer group ID indicating SL-POS, in the case of group member discovery
A service type (V2X service type) indicating SL-POS, in the case of a unicast mode V2X communication procedure
A service type indicating SL-POS, in the case of groupcast or broadcast mode V2X communication procedure
An SL-POS role (e.g., an anchor UE, a located UE, a server UE, a client UE, an assistant UE, a target UE, or the like)
An SL-POS measurement scheme (e.g., an SL, an SL-azimuth angle of arrival (AOA), SL-time difference of arrival (TDOA), or the like)
An SL-POS measurement scheme (e.g., SL PRS based Rx-Tx measurement, SL PRS based RSTD measurement, SL PRS based RSRP measurement, SL PRS based RSRPP measurement, SL PRS based RTOA measurement, SL PRS based AoA and SL zenith of arrival (ZoA) measurement, or the like)
Additional information (e.g., accuracy and/or uncertainty of a location and its source, accuracy and/or uncertainty of measurement and/or an SL-PRS, a supported bandwidth and/or SCS and/or carrier, coverage information, synchronization source information, a synchronization hierarchy, synchronization accuracy and/or uncertainty, LMF and/or server UE reachability, an LMF ID, a UE ID, an SL-POS mode, or the like).
Cell access related information of a UE that transmits a discovery message
Serving cell related information of a UE that transmits a discovery message

According to one embodiment, in association with at least one of an SL-POS role, an SL-POS measurement scheme, additional information, cell access related information, and serving cell related information, the announcement 715 may be used for informing preference while the UE A 705 performs an SL-POS operation, a request for identifying whether the UE B 710 or another UE provides support, a requirement while the UE A 705 performs an SL-POS operation, or information/function which the UE A 705 supports or retains.

According to another embodiment, preference, a support request, a requirement, or supported information/function included in the announcement 715 may be transmitted/distinguished via different messages or may be distinguished in a single message (e.g., a different IE name as an identifier indicating preference, identification of support or not support, a requirement request, or supported information/function information, or an identifier included in an IE and indicating a request or a requirement).

A ProSe identifier, an application layer group ID, and a V2X service type may be an identifier for distinguishing a ProSe application associated with a ProSe operation, an identifier for distinguishing users in at least one predetermined application, and an identifier for distinguishing a V2X service type (e.g., an ITS application identifier (ITS-AID), a provider service identifier (PSID), or an application identifier (AID)), and may be based on the definitions in 3GPP TS 23.304, 23.303, 23.287.

According to still another embodiment, the SL-POS role may be at least one of an anchor UE, a located UE, a server UE, a client UE, an assistant UE, and a target UE, and a single UE may perform multiple roles in parallel. Whether each SL-POS role is supported and/or required may be expressed by a bit map (e.g., Table 1), and a role supported at a minimum may be expressed by 2 bits of an anchor UE or a target UE.

```
TABLE 1
The IE SL-PositioningRoles is used to indicate several sidelink
positioning roles using a bit map.
  --ASN1START
  SL-PositioningRoles ::= SEQUENCE
    posRoles BIT STRING { Anchor (0),
```

Located (1),
Server (2),
Client (3),
Assistant (4),
Target (5),

```
    } (SIZE (1..x)),
    ...
  }
  -- ASN1STOP
```

Whether each SL-POS role is supported and/or required may be expressed by indicating an information element (IE) including detailed information of each SL-POS role as being optional (e.g., Table 2). In the case in which an IE indicating whether each SL-POS role is supported and/or required is not present, a UE (e.g., the UE 710) that receives a discovery message transmitted by the UE A 705 may determine that the UE A 705 does not support or require the corresponding SL-POS role. The detailed information of each SL-POS role may include at least one of a supported or required SL-POS measurement scheme for each role or additional information.

```
TABLE 2
  The IE SL-PositioningRoles is used to indicate several sidelink
positioning roles.
  -- ASN1START
  SL-PositioningRoles ::= SEQUENCE {
```

| | | |
|---|---|---|
| anchorCapabilities | AnchorCapabilities | OPTIONAL, |
| locatedCapabilities | LocatedCapabilities | OPTIONAL, |
| serverCapabilities | ServerCapabilities | OPTIONAL, |
| clientCapabilities | ClientCapabilities | OPTIONAL, |
| assistantCapabilities | AssistantCapabilities | OPTIONAL, |
| targetCapabilities | TargetCapabilities | OPTIONAL |
| }, | | |
| ... | | |
| } | | |
| -- ASN1STOP | | |

In an embodiment, an SL-POS measurement scheme may be at least one of an SL, an SL-AOA, and an SL-TDOA, and multiple measurement schemes may be supported in parallel. The SL-POS measurement scheme may be an SL-POS measurement scheme supported by a UE (e.g., the UE 705) that transmits a discovery message, and/or may be an SL-POS measurement scheme that needs to be supported by a UE (e.g., the UE 710) that receives a discovery message.

In another embodiment, supported or required SL-POS measurement scheme information may be transmitted/distinguished via different discovery messages or may be distinguished in a single discover message (e.g., a different IE name as an identifier indicating information associated with a supported SL-POS measurement scheme or information associated with a required SL-POS measurement scheme, or an identifier included in an IE and indicating a request or a requirement). In yet another embodiment, whether each SL-POS measurement scheme is supported and/or required may be expressed by a bit map (e.g., a part of Table 3).

```
TABLE 3
  The IE SL-PositioningCapabilities is used to indicate several sidelink
positioning capabilities using a bit map.
  -- ASN1START
    SL-PositioningCapabilities ::= SEQUENCE {
      posCapabilities BIT STRING { SL (0),
      SL-AOA (1),
      SL-TDOA (2)
      } (SIZE (1..x)),
      ...
  }
  -- ASN1STOP
```

Whether each SL-POS measurement scheme is supported and/or required may be indicated by expressing an IE including detailed information of each SL-POS measurement role as being optional (e.g., Table 4). In the case in which an IE indicating whether each SL-POS measurement scheme is supported and/or required is not present, a UE (e.g., the UE 710) that receives a discovery message transmitted by the UE A 705 may determine that the UE A 705 does not support or require the corresponding SL-POS measurement scheme. The detailed information of each SL-POS measurement scheme may include at least one among supported or required accuracy, uncertainty, an SL-POS role, and additional information.

```
TABLE 4
  The IE SL-PositioningCapabilities is used to indicate several sidelink
positioning capabilities.
  -- ASN1START
    SL-PositioningCapabilities ::= SEQUENCE {
```

| | | |
|---|---|---|
| sl-Capabilities | SL-Capabilities | OPTIONAL, |
| sl-AOACapabilities | SL-AOACapabilities | OPTIONAL, |
| sl-TDOACapabilities | SL-TDOACapabilities | OPTIONAL, |
| }, | | |
| ... | | |
| } | | |
| -- ASN1STOP | | |

According to an embodiment, an SL-POS measurement scheme may be at least one among SL PRS based Rx-Tx measurement, SL PRS based RSTD measurement, SL PRS based RSRP measurement, SL PRS based RSRPP measurement, SL PRS based RTOA measurement, and SL PRS based AoA and SL Zenith of Arrival (ZoA) measurement, and multiple measurement schemes may be supported in parallel. The SL-POS measurement scheme may be an SL-POS measurement scheme supported by a UE (e.g., the UE 705) that transmits a discovery message, and/or may be an SL-POS measurement scheme that needs to be supported by a UE (e.g., the UE 710) that receives a discovery message.

According to another embodiment, supported or required SL-POS measurement scheme information may be transmitted/distinguished via different discovery messages or may be distinguished in a single discover message (e.g., a different IE name as an identifier indicating information associated with a supported SL-POS measurement scheme or information associated with a required SL-POS measurement scheme, or an identifier included in an IE and indicating a request or a requirement). According to still another embodiment, whether each SL-POS measurement scheme is supported and/or required may be expressed by a bit map (e.g., a part of Table 5).

```
TABLE 5
  The IE SL-PositioningCapabilities is used to indicate several sidelink
positioning capabilities using a bit map.
  -- ASNISTART
  SL-PositioningCapabilities ::= SEQUENCE {
  posCapabilities BIT STRING { SL PRS based Rx-Tx
measurement (0)
  SL PRS based RSTD measurement (1),
  SL PRS based RSRP measurement (2),
  SL PRS based RSRPP measurement (3),
  SL PRS based RTOA measurement (4),
  SL PRS based Azimuth of Arrival (AoA) and SL Zenith of Arrival
(ZoA) measurement (5)
  } (SIZE (1..x)),
  ...
}
-- ASN1STOP
```

Whether each SL-POS measurement scheme is supported and/or required may be indicated by expressing an IE including detailed information of each SL-POS measurement scheme as being optional (e.g., Table 6). In the case in which an IE indicating whether each SL-POS measurement scheme is supported and/or required is not present, a UE (e.g., the UE 710) that receives a discovery message transmitted by the UE A 705 may determine that the UE A 705 does not support or require the corresponding SL-POS measurement scheme. The detailed information of each SL-POS measurement scheme may include at least one among supported or required accuracy, uncertainty, an SL-POS role, and additional information.

```
TABLE 6
  The IE SL-PositioningCapabilities is used to indicate several sidelink
positioning capabilities.
  -- ASN1START
  SL-PositioningCapabilities ::= SEQUENCE {
    rxtxMeasCapabilities  RxTxMeasCapabilities  OPTIONAL,
    rstdMeasCapabilities  RSTDMeasCapabilities  OPTIONAL,
    rsrpMeasCapabilities  RSRPMeasCapabilities  OPTIONAL,
    rsrppMeasCapabilities  RSRPPMeasCapabilities  OPTIONAL,
    rtoaMeasCapabilities  RTOAMeasCapabilities  OPTIONAL,
    aoazoaMeasCapabilities  AoAZoAMeasCapabilities
OPTIONAL
    },
    ...
  }
  -- ASN1STOP
```

In an embodiment, additional information may be at least one piece of information among accuracy and/or uncertainty of a location and its source, accuracy and/or uncertainty of measurement and/or an SL-PRS, a supported bandwidth and/or carrier, coverage information, synchronization source information, a synchronization hierarchy, synchronization accuracy and/or uncertainty, LMF and/or server UE reachability, an LMF ID, a UE ID, and an SL-POS mode, and may include multiple pieces of information at the same time. The additional information may be information provided by a UE (e.g., the UE 705) that transmits a discovery message and/or a requirement that needs to be supported by a UE (e.g., the UE 710) that receives a discovery message.

In another embodiment, supported or required additional information may be transmitted/distinguished via different discovery messages, or may be distinguished in a single discover message (e.g., a different IE name as an identifier indicating provided additional information or required additional information, or an identifier included in an IE and indicating a request or a requirement).

In still another embodiment, in the case in which location information of a UE (e.g., a located UE) is identifiable, the accuracy and/or uncertainty of a location and its source may be included (e.g., in the case in which a UE is a located UE and of which the location information currently available is not present, location information may not be included, or an indicator is used to indicate that no location information currently available is present), and accuracy and/or uncertainty may be expressed as a part of the form of Table 7 depending on accuracy. In addition, a source used for obtaining the location information of the UE may be expressed as a part of the form of a bitmap or the form of Enumerated of Table 8.

TABLE 7

| | |
|---|---|
| LocationCoordinates ::= CHOICE { | |
| ellipsoidPoint | Ellipsoid-Point, |
| ellipsoidPointWithUncertaintyCircle | Ellipsoid- |
| PointWithUncertaintyCircle, | |
| ellipsoidPointWithUncertaintyEllipse | |
| EllipsoidPointWithUncertaintyEllipse, | |
| polygon | Polygon, |
| ellipsoidPointWithAltitude | EllipsoidPointWithAltitude, |

ellipsoidPointWithAltitudeAndUncertaintyEllipsoid

EllipsoidPointWithAltitudeAndUncertaintyEllipsoid,

ellipsoidArc EllipsoidArc,

...,

```
    highAccuracyEllipsoidPointWithUncertaintyEllipse-v1510
HighAccuracyEllipsoidPointWithUncertaintyEllipse-r15,
    highAccuracyEllipsoidPointWithAltitudeAndUncertaintyEllipsoid-
```

v1510

HighAccuracyEllipsoidPointWithAltitudeAndUncertaintyEllipsoid-r15,
ha-EllipsoidPointWithScalableUncertaintyEllipse-v1680

| | |
|---|---|
| | HA- |
| EllipsoidPointWithScalableUncertaintyEllipse-r16, | |

ha-EllipsoidPointWithAltitudeAndScalableUncertaintyEllipsoid-v1680

HA-

EllipsoidPointWithAltitudeAndScalableUncertaintyEllipsoid-r16
}

TABLE 8

| | | |
|---|---|---|
| LocationSource-r13 ::= BIT STRING { | a-gnss | (0), |
| | wlan | (1), |
| | bt | (2), |
| | tbs | (3), |
| | sensor | (4), |
| | ha-gnss-v1510 | (5), |
| | motion-sensor-v1550 | (6), |
| | dl-tdoa-r16 | (7), |
| | dl-aod-r16 | (8) } (SIZE(1..16)) |

LocationSource ENUMERATED {a-gnss, wlan, bt, tbs, sensor, ha-
gnss, motion-sensor, dl-tdoa, dl-aod, ...},

According to an embodiment, the accuracy and/or uncertainty of measurement and/or SL-PRS may express accuracy for performing SL-POS, and may be expressed as a part of the form of Table 9.

TABLE 9
NR-TimingQuality-r16 ::= SEQUENCE {

| | |
|---|---|
| timingQualityValue-r16 | INTEGER (0..31), |
| timingQualityResolution-r16 | ENUMERATED {mdot1, m1, |
| m10, m30, ...}, | |
| ... | |
| } | |

The supported bandwidth and/or subcarrier spacing (SCS) and/or carrier may indicate a bandwidth and/or SCS and/or frequency range in which the UE is capable of transmitting or receiving an SL-positioning reference signal (SL-PRS) in order to perform SL-POS. In addition, the supported bandwidth and/or subcarrier spacing (SCS) and/or carrier may express FR1 and FR2 and an unlicensed band, or a supported or maximally supported BW, and information for each SCS as a part of the form of Table 10.

TABLE 10

| | |
|---|---|
| NR-DL-PRS-ProcessingCapability-r16 ::= SEQUENCE { | |
| prs-ProcessingCapabilityBandList-r16 SEQUENCE | (SIZE |
| (1..nrMaxBands-r16)) OF | |

PRS-

| | |
|---|---|
| ProcessingCapabilityPerBand-r16, | |
| maxSupportedFreqLayers-r16 | INTEGER (1..4), |
| simulLTE-NR-PRS-r16 | ENUMERATED { |
| supported } OPTIONAL, | |
| ..., | |
| [[ | |

dummy ENUMERATED { m1, m2, ...

| | |
|---|---|
| } OPTIONAL | |
| ]] | |
| } | |
| PRS-ProcessingCapabilityPerBand-r16 ::= SEQUENCE { | |
| freqBandIndicatorNR-r16 | FreqBandIndicatorNR-r16, |
| supportedBandwidthPRS-r16 | CHOICE { |
| fr1 | ENUMERATED {mhz5, |
| mhz10, mhz20, mhz40,mhz50, mhz80, mhz100}, | |
| fr2 | ENUMERATED {mhz50, |
| mhz100, mhz200, mhz400}, | |
| nr-u | ENUMERATED |

{mhz5, mhz10, mhz20, mhz40,mhz50, mhz80, mhz100, mhz200, mhz400},

| | |
|---|---|
| ... | |
| }, | |
| dl-PRS-BufferType-r16 | ENUMERATED {type1, type2, |
| ...}, | |
| durationOfPRS-Processing-r16 | SEQUENCE { |

durationOfPRS-ProcessingSymbols-r16 ENUMERATED
{nDot125, nDot25, nDot5, n1, n2, n4, n6, n8, n12, n16, n20, n25, n30, n32, n35,
n40, n45, n50},

| | |
|---|---|
| durationOfPRS-ProcessingSymbolsInEveryTms-r16 | |
| | ENUMERATED {n8, n16, |
| n20, n30, n40, n80, n160,n320, n640, n1280}, | |
| ... | |
| }, | |

maxNumOfDL-PRS-ResProcessedPerSlot-r16 SEQUENCE {

| | |
|---|---|
| scs 15-r16 | ENUMERATED {n1, n2, |

n4, n8, n16, n24, n32, n48, n64} OPTIONAL,

| | |
|---|---|
| scs30-r16 | ENUMERATED {n1, n2, |

n4, n8, n16, n24, n32, n48, n64} OPTIONAL,

| | |
|---|---|
| scs60-r16 | ENUMERATED {n1, n2, |

n4, n8, n16, n24, n32, n48, n64} OPTIONAL,

| | |
|---|---|
| scs120-r16 | ENUMERATED {n1, n2, |

n4, n8, n16, n24, n32, n48, n64} OPTIONAL,

```
        ...,
        [[
```

scs15-v1690 ENUMERATED {n6, n12}

OPTIONAL,

scs30-v1690 ENUMERATED {n6, n12}

OPTIONAL,

scs60-v1690 ENUMERATED {n6, n12}

OPTIONAL,

```
        scs 120-v1690  ENUMERATED {n6, n12}
  OPTIONAL
    ]]
  },
  ...
}
```

Coverage information may indicate whether a UE is present in the coverage of a network (in-coverage (IC)), or outside the coverage of the network (out-of-coverage (OOC)), or may express actual network coverage information in the form of Table 11. That may include the case in which an OOC UE that is actually out of the coverage of a network is recognized as an IC, such as an L2 U2N Remote UE or the like, and is actually present outside the coverage of the network. (When an out of coverage L2 U2N Remote UE can connect to network, the L2 U2N Remote continues indicate out-of-coverage information)

TABLE 11

| | |
|---|---|
| inCoverage-r16 | BOOLEAN, |

According to one embodiment, synchronization source information may indicate a synchronization source configured by a network so as to be preferentially used by a user, a synchronization source actually being used, or a synchronization source configured by the network not to be used but is actually being used, as a part of the form of Table 12. The actually used synchronization source may include the case in which a synchronization source is used by an OOC UE that is configured by a network to use a gNB or an eNB as a synchronization source, such as an L2 U2N Remote UE, and the case in which another synchronization source is used since the UE is outside the coverage of a network. (When an out of coverage L2 U2N Remote UE receives SIB12 with sl-SyncPriority set to gnbEnb, the L2 U2N Remote continues using the current synchronization source)

TABLE 12

| | |
|---|---|
| SynchronizationSource ::= BIT STRING | {gnss (0), |
| | gnbEnb (1), |
| | syncRefUE (2) |
| } (SIZE(1..x)) | |
| sl-SyncPriority-r16 | ENUMERATED {gnss, gnbEnb} |

According to another embodiment, the synchronization hierarchy may express a synchronization source and information associated with a synchronization source, currently used by a UE, in the form of a sidelink synchronization signal identifier (SLSSID). The SLSSID may be selected via a procedure of Table 13.

```
TABLE 13
  The UE shall select the SLSSID and the slot in which to transmit SLSS
as follows:
    1>  if triggered by NR sidelink communication/discovery and
in coverage on the frequency used for NR sidelink
communication/discovery, as defined in TS 38.304; or
    1>  if triggered by NR sidelink communication/discovery, and
out of coverage on the frequency used for NR sidelink
communication/discovery, and the concerned frequency is included in sl-
FreqInfoToAddModList in sl-ConfigDedicatedNR within
RRCReconfiguration message or included in sl-FreqInfoList within SIB12:
      2>  if the UE has selected GNSS as synchronization reference
in accordance with 5.8.6.2:
        3>  select SLSSID 0;
        3>  use sl-SSB-TimeAllocation1 included in the entry of
    configured sl-SyncConfigList corresponding to the concerned
    frequency, that includes txParameters and gnss-Sync;
        3>  select the slot(s) indicated by sl-SSB-TimeAllocation1;
      2>  if the UE has selected a cell as synchronization reference in
accordance with 5.8.6.2:
        3>  select the SLSSID included in the entry of
configured sl-SyncConfigList corresponding to the concerned
frequency, that includes txParameters and does not include gnss-
Sync;
        3>  select the slot(s) indicated by sl-SSB-TimeAllocation1;
      1>  else if triggered by NR sidelink communication/discovery
and the UE has GNSS as the synchronization reference:
        2>  select SLSSID 0;
        2>  if sl-SSB-TimeAllocation3 is configured for the frequency
used in SidelinkPreconfigNR:
        3>  select the slot(s) indicated by sl-SSB-TimeAllocation3;
      2>  else:
        3>  select the slot(s) indicated by sl-SSB-TimeAllocation1;
      1>  else:
        2> select the synchronisation reference UE (i.e. SyncRef UE)
as defined in 5.8.6;
        2>  if the UE has a selected SyncRef UE and inCoverage in the
MasterInformationBlockSidelink message received from this UE is set
to true; or
        2>  if the UE has a selected SyncRef UE and inCoverage in the
MasterInformationBlockSidelink message received from this UE is set
to false while the SLSS from this UE is part of the set defined for out of
coverage, see TS 38.211:
          3>  select the same SLSSID as the SLSSID of the
selected SyncRef UE;
          3>  select the slot in which to transmit the SLSS
according to the sl-SSB-TimeAllocationl or sl-SSB-TimeAllocation2
included in the preconfigured sidelink parameters corresponding to
the concerned frequency, such that the timing is different from the
SLSS of the selected SyncRef UE;
          2>  else if the UE has a selected SyncRef UE and the SLSS
from this UE was transmitted on the slot(s) indicated sl-SSB-
TimeAllocation3, which is configured for the frequency used in
SidelinkPreconfigNR:
            3> select SLSSID 337;
            3> select the slot(s) indicated by sl-SSB-TimeAllocation2;
          2>  else if the UE has a selected SyncRef UE:
            3>  select the SLSSID from the set defined for out of
coverage having an index that is 336 more than the index of the
SLSSID of the selected SyncRef UE, see TS 38.211;
            3>  select the slot in which to transmit the SLSS
according to sl-SSB-TimeAllocation1 or sl-SSB-TimeAllocation2
included in the preconfigured sidelink parameters corresponding to
the concerned frequency, such that the timing is different from the
SLSS of the selected SyncRef UE;
          2>  else (i.e. no SyncRef UE selected):
              3>  if the UE has not randomly selected an SLSSID:
                4>  randomly select, using a uniform distribution, an
SLSSID from the set of sequences defined for out of coverage
except SLSSID 336 and 337, see TS 38.211;
                4>  select the slot in which to transmit the SLSS
according to the sl-SSB-TimeAllocation1 or sl-SSB-
TimeAllocation2 (arbitrary selection between these) included in
the preconfigured sidelink parameters in SidelinkPreconfigNR
corresponding to the concerned frequency;
```

According to yet another embodiment, synchronization accuracy and/or uncertainty may include at least one of the accuracy of a synchronization source and uncertainty, and may be expressed as a part of the form of Table 14.

TABLE 14
GNSS-ReferenceTime ::= SEQUENCE {

| | |
|---|---|
| gnss-SystemTime | GNSS-SystemTime, |
| referenceTimeUnc | INTEGER (0..127) |
| OPTIONAL, -- Cond noFTA | |

gnss-ReferenceTimeForCells SEQUENCE (SIZE (1..16)) OF

| | |
|---|---|
| | GNSS-ReferenceTimeForOneCell |
| OPTIONAL, -- Need ON | |
| ... | |
| } | |

```
  GNSS-ReferenceTimeForOneCell ::= SEQUENCE {
    networkTime  NetworkTime,
```

| | |
|---|---|
| referenceTimeUnc | INTEGER (0..127), |
| bsAlign | ENUMERATED {true} OPTIONAL, |
| ... | |
| } | |

NR-TimingQuality-r16 ::= SEQUENCE {

| | |
|---|---|
| timingQualityValue-r16 | INTEGER (0..31), |

timingQualityResolution-r16 ENUMERATED {mdot1, m1, m10,

```
m30, ...},
    ...
  }
```

According to still another embodiment, LMF and/or server UE reachability may indicate the condition of a connection with an LMF and/or server UE, and may be expressed as a part of the form of Table 15. ServerUECapabilities may include at least one among a measurement scheme supported by a connectable server UE, and/or a location calculation function, and/or an SL-POS location calculation function.

TABLE 15

| | |
|---|---|
| lmfRechability | BOOLEAN, |
| serverUERechability | BOOLEAN, |
| serverUERechability | ServerUECapabilities, |

An LMF ID may be an identifier for identifying an LMF that is currently connected or connectable, and may be a routing ID provided by an AMF or a temporary or permanent LMF ID provided by an LMF.

According to an embodiment, a UE ID may be an identifier used for an LMF or a server UE to identify a corresponding UE, or may be a temporary ID provided by a network (e.g., a generic public subscription identifier (GPSI), a mobile station integrated services digital network (ISDN) number (MSISDN)) or a permanent ID (e.g., a subscription permanent identifier (SUPI), a permanent equipment identifier (PEI), an international mobile subscriber identity (IMSI), an international mobile equipment identity (IMEI)), or a temporary or permanent UE ID (e.g., a Layer-2 ID, an application ID, a user info ID) that an LMF or server UE allocates or that a UE autonomously allocates (e.g., a Layer-2 ID, an application ID, a user info-ID).

An SL-POS mode indicates that SL-POS is performable via interoperation with an LMF when SL-POS is performed, SL-POS is performable solely, or hybrid SL-POS is performable, which simultaneously performs another positioning scheme (e.g., NR positioning) different from SL-POS (e.g., a part of Table 16).

TABLE 16

| SL-PositioningModes ::= SEQUENCE { | | |
|---|---|---|
| slPosModes BIT STRING { standalone (0), | | |
| | ue-based | (1), |
| | ue-assisted | (2), |
| | sl-pos | (3), |
| | uu-pos | (4), |

| | |
|---|---|
| } (SIZE (1..x)), | |
| ... | |
| } | |
| sl-pos | BOOLEAN, |
| uu-pos | BOOLEAN, |

According to an embodiment, cell access related information of a UE that transmits a discovery message may be provided in the form of a part of Table 17, and may include at least one of a public land mobile network (PLMN), a NR global cell identity (NCGI), and a cell ID. An OOC UE may use an SL-POS procedure and parameters which are authorized for the use in an IC UE and corresponding PLMN.

```
TABLE 17
      NCGI
  The IE NCGI specifies the NR Cell Global Identifier (NCGI) which is
used to identify NR cells globally (TS 38.331).
```

| | |
|---|---|
| -- ASN1START | |
| NCGI-r15 ::= SEQUENCE { | |
| mcc-r15 | SEQUENCE (SIZE (3)) OF |
| INTEGER (0..9), | |
| mnc-r15 | SEQUENCE (SIZE (2..3)) OF |
| INTEGER (0..9), | |

nr-cellidentity-r15 BIT STRING (SIZE (36))

| | |
|---|---|
| } | |
| -- ASN1STOP | |
| cellAccessRelatedInfo-r17 | CellAccessRelatedInfo, |

Serving cell related information of a UE that transmits a discovery message may be in the form of a part of Table 18, and may include at least one of a PCI and a carrier frequency.

```
TABLE 18
    NR-PhysCellId
  The IE NR-PhysCellId specifies the NR physical cell identifier (TS
```

```
38.331).
  -- ASN1START
  NR-PhysCellID-r16 ::= INTEGER (0..1007)
  -- ASN1STOP
    ARFCN-ValueNR
```

The IE ARFCN-ValueNR is used to indicate the ARFCN applicable for
a downlink, uplink or bi-directional (TDD) NR global frequency raster, as
defined in TS 38.101-2 and TS 38.101-1.

```
  -- ASN1START
  ARFCN-ValueNR-r15 ::= INTEGER (0..3279165)
  -- ASN1STOP
```

```
  SL-ServingCellInfo-r17 ::=  SEQUENCE {
    sl-PhysCellId-r17  PhysCellId,
    sl-CarrierFreqNR-r17  ARFCN-ValueNR
  }
```

The UE B 710 that receives the discovery message 715 transmitted by the UE A 705 may transmit the additional parameters announcement request 720 to the UE A 705 that transmits the discovery message 715, in order to obtain at least one of an SL-POS role, an SL-POS measurement scheme, additional information, cell access related information, and serving cell related information. The additional parameters announcement request 720 may be used for obtaining information which the UE B 710 prefers while performing an SL-POS operation, which is used when the UE B requests information on whether the UE A 705 is supported, or which is required when an SL-POS operation is performed with the UE A 705, in association with at least one piece of information among an SL-POS role, an SL-POS measurement scheme, additional information, cell access related information, and service cell related information.

According to another embodiment, information that may be included in the additional parameters announcement request 720 transmitted by the UE B 710 may be at least one piece of information/functions which may be included in the announcement 715 and may be supported by the UE A 705, required by the UE A 705, or supported by the UE B 710.

According to yet another embodiment, preferred or supported or required information/function included in the additional parameters announcement request 720 may be transmitted/distinguished via different messages or may be distinguished in a single message (e.g., a different IE name as an identifier indicating preferred, supported, or required information/function, or an identifier included in an IE and indicating a request or a requirement).

According to still another embodiment, upon receiving the additional parameters announcement request 720 from the UE B 710 or receiving an additional parameters announcement request from another UE, the UE A 705 may include the information/function that the UE B 710 or the other UE needs to obtain from the UE A 705 in an additional parameters announcement response 725 and may transmit the same.

According to an embodiment, information that may be included in the additional parameters announcement response 725 that the UE A 705 transmits may be at least one piece of the preferred information/functions that may be included in the received additional parameters announcement request 720.

In an embodiment, in the case in which the UE A 705 receives a request associated with support via the additional parameters announcement request 720, the information that may be included in the additional parameters announcement response 725 to be transmitted may include at least one piece of information/functions that the UE A 710 is capable of supporting or transmitting.

In another embodiment, information that may be included in the additional parameters announcement response 725 that the UE A 705 transmits may be at least one piece of the required information/functions that may be included in the received additional parameters announcement request 720.

In yet another embodiment, information that may be included in the discovery message 715, 720, and 725 may be directly defined in a discovery message that may be used for SL-POS or for common use in 3GPP TS 24.554 that defines a discovery message format.

In still another embodiment, information that may be included in the discovery message 715, 720, and 725 may be imported from a standard different from 3GPP TS 24.554 including an SLPP and/or RRC and may be included in the form of a container.

According to an embodiment, SLPP information elements may be defined to be included in a discovery message for transmission (SLPP information elements that are transferred in Discovery Message) and RRC information elements may be defined to be included in a discovery message for transmission (RRC information elements that are transferred in Discovery Message). In this instance, TAGs for distinguishing respective IEs may be specified in order to import IEs in an ASN.1 format, and may be defined to be imported from another standard using IMPORTS and FROM. According to an embodiment, the above-described Table 17 and/or Table 18 may be defined in the form of Table 19 in another standard including an SLPP and/or RRC, and other information may also be defined in a form that is capable of being imported.

According to an embodiment, the structure of a container capable of being used in a discovery message format of TS 24.554 may be as shown in a part of Table 20.

According to one embodiment, upon receiving a discovery message that the UE A 705 transmits (e.g., the announcement 715 and/or additional parameters announcement response 725), the UE B 710 may transfer the identifier of the UE A 705 that transmits the corresponding discovery message and the UE A 705's preference, identification of support or not support, a requirement request, or supported information/function information to a ProSe/V2X layer and/or an SLPP layer and/or an LPP layer. The SLPP and/or LMF layer may transfer, to a server UE and/or LMF, information associated with at least one UE among neighboring UEs that is obtained via a discovery procedure, thereby assisting the server UE or LMF to determine a measurement scheme, to transmit assistant data, and/or to perform a location calculation function and/or an SL-POS location calculation function, or to select another UE to perform SL-POS.

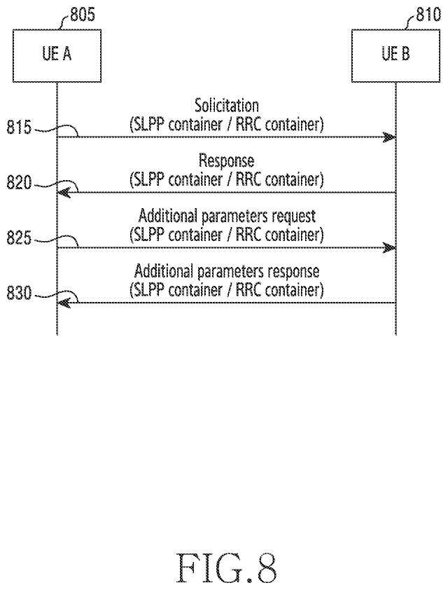

FIG. 8 is a flowchart illustrating a discovery process using discovery model B according to an embodiment of the disclosure.

Referring to FIG. 8, UE A 805 may broadcast a discovery message (e.g., a solicitation 815) so as to enable a UE (e.g., UE B 810) that presents in a communication range to discover the UE A 805. Alternatively, the UE A 805 may include target discovery info in the solicitation 815 so that a predetermined UE or UEs in a predetermined group transmits a response 820. The discovery message is not limited to the solicitation 815, and may include all messages used for a UE discovery procedure including the response 820, an additional parameters request 825, an additional parameters response 830, and an announcement. The application layer of the UE A 805 or the LMF may indicate, to an SLPP layer, starting or stopping transmission of the discovery message 815, and the SLPP layer may indicate, to a ProSe/V2X layer, transmission of the discovery message 815. The UE B 815 that receives the discovery message 815 may identify the UE A 805 based on the information included in the discovery message 815 and a Layer-2 ID for transmitting the discovery message 815.

In an embodiment, in the discovery message 815, 820, 825, and 830, at least one piece of information among the following information may be included, and the information included in the discovery message 815, 820, 825, and 830 and a method of including the information may be the same as, or similar to, the description provided in FIG. 7.
A ProSe identifier indicating SL-POS, in the case of 5G ProSe direct discovery
An application layer group ID indicating SL-POS, in the case of group member discovery
A service type (V2X service type) indicating SL-POS, in the case of a unicast mode V2X communication procedure
A service type indicating SL-POS, in the case of a groupcast or broadcast mode V2X communication procedure
An SL-POS role (e.g., an anchor UE, a located UE, a server UE, a client UE, an assistant UE, a target UE, or the like)
An SL-POS measurement scheme (e.g., an SL, SL-AOA, SL-TDOA, or the like)
An SL-POS measurement scheme (e.g., SL PRS based Rx-Tx measurement, SL PRS based RSTD measurement, SL PRS based RSRP measurement, SL PRS based RSRPP measurement, SL PRS based RTOA measurement, SL PRS based AoA and SL zenith of arrival (ZoA) measurement, or the like)
Additional information (e.g., accuracy and/or uncertainty of a location and its source, accuracy and/or uncertainty of measurement and/or SL-PRS, a supported bandwidth and/or SCS and/or carrier, coverage information, synchronization source information, a synchronization hierarchy, synchronization accuracy and/or uncertainty, LMF and/or server UE reachability, an LMF ID, a UE ID, an SL-POS mode, or the like).
Cell access related information of a UE that transmits a discovery message
Serving cell related information of a UE that transmits a discovery message

In another embodiment, in association with at least one of an SL-POS role, an SL-POS measurement scheme, additional information, cell access related information, and serving cell related information, the solicitation 815 may be used for informing preference while the UE A 805 performs an SL-POS operation, a request for identifying whether the UE B 810 or another UE provides support, a requirement when the UE A 805 operates an SL-POS operation, or information/function that the UE A 805 supports or retains.

In yet another embodiment, preferred, supported, or required information included in the solicitation 815 may be transmitted/distinguished via different messages or may be distinguished in a single message (e.g., a different IE name as an identifier indicating preference, identification of support or not support, or a requirement request, or supported information/function information, or an identifier included in an IE and indicates a request or a requirement).

When the UE B 810 receives the solicitation 815 from the UE A 805, the UE B 810 may transfer the identifier of the UE A 805 that transmits the corresponding discovery message and the UE A 805's preference, identification of support or not support, a requirement request, or supported information/function information to a ProSe/V2X layer, and/or an SLPP layer, and/or an LPP layer.

According to an embodiment, in the case in which the ProSe/V2X layer, and/or the SLPP layer, and/or the LPP layer of the UE B 810 needs to perform SL-POS with the UE A 805 based on the UE A 805's preference, identification of support or not support, a requirement request, or supported information/function information, the ProSe/V2X layer, and/or the SLPP layer, and/or the LPP layer may inform the UE A 805 of the existence of the UE B 810 via the response message 820.

Information that may be included in the response 820 that the UE B 810 transmits may be at least one piece of the preferred information/functions that may be included in the solicitation 815 received from the UE A 805.

According to an embodiment, information that may be included in the response 820 that the UE A 810 transmits may be at least one piece of the information/functions which need to be identified by request in association with whether it is supported, and which may be included in the solicitation 815 received from the UE A 805.

Information that may be included in the response 820 that the UE B 810 transmits may be at least one piece of the information/functions which require support and may be included in the solicitation 815 received from the UE A 805.

According to another embodiment, information that may be included in the response 820 that the UE B 810 transmits may be at least one piece of information/functions which are supported by the UE B 810, which are associated with the information/functions that are supported by the UE A 805, and which may be included in the solicitation 815.

According to yet another embodiment, information that may be included in the response 820 that the UE B 810 transmits may be at least one piece of the information/functions supported by the UE B 810.

According to an embodiment, in the case in which the UE A 805 and the UE B 810 discover each other via the solicitation 815 and the response 820, the UE A 805 or the UE B 810 may transmit the additional parameters request 825, in order to obtain at least one among an SL-POS role, an SL-POS measurement scheme, additional information, cell access related information, and serving cell related information from a counterpart UE. Although FIG. 8 illustrates that the UE A 805 transmits the additional parameters request 825 to the UE B 810, any UE 805 and 810 is capable of transmitting the additional parameters request 825. The additional parameters request 825 may be, for example, used for obtaining information which the UE A 805 prefers while performing an SL-POS operation, which is used when the UE A requests information on whether it is supported by the UE B 810, or which is required when an SL-POS operation is performed with the UE B 810, in association with an SL-POS role, an SL-POS measurement scheme, additional information, cell access related information, and service cell related information.

Preferred or supported or required information/function included in the additional parameters request 825 may be transmitted/distinguished via different messages or may be distinguished in a single message (e.g., a different IE name as an identifier indicating preferred, supported, or required information/function, or an identifier included in an IE and indicating a request or a requirement).

According to an embodiment, in the case in which the UE B 810 receives the additional parameters request 825 from the UE A 805, the UE B 810 may include the information/function that the UE A 805 needs to obtain in the additional parameters response 830 and may transmit the same.

According to another embodiment, information that may be included in the additional parameters response 830 that the UE B 810 transmits may be at least one piece of the preferred information/functions that may be included in the received additional parameters request 825.

According to yet another embodiment, in the case in which the UE B 810 receives a request for identifying support or not support via the additional parameters request 825, the information that may be included in the additional parameters response 830 to be transmitted may include at least one piece of information/functions in association with which the UE A 805 requests identifying whether it is supported.

According to still another embodiment, in the case in which the UE B 810 receives a request for an information/function requirement via the additional parameters request 825, the information that may be included in the additional parameters response 830 to be transmitted may include at least one piece of information/functions in association with which the UE A 805 requests an information/function requirement.

Upon receiving a discovery message that the UE B 810 transmits (e.g., the response 820 and/or additional parameters response 830), the UE A 805 may transfer the identifier of the UE B 810 that transmits the corresponding discovery message and the UE B 810's preference, identification of support or not support, a requirement request, or supported information/function information to a ProSe/V2X layer, and/or an SLPP layer, and/or an LPP layer. The ProSe/V2X layer, and/or the SLPP and/or the LMF layer may transfer information associated with at least one UE among neighboring UEs that is obtained via a discovery procedure to a ProSe/V2X server, and/or a server UE, and/or an LMF, thereby assisting the server UE or LMF to determine a measurement scheme, to transmit assistant data, and/or to perform a location calculation function and/or an SL-POS location calculation function, or to select another UE to perform SL-POS.

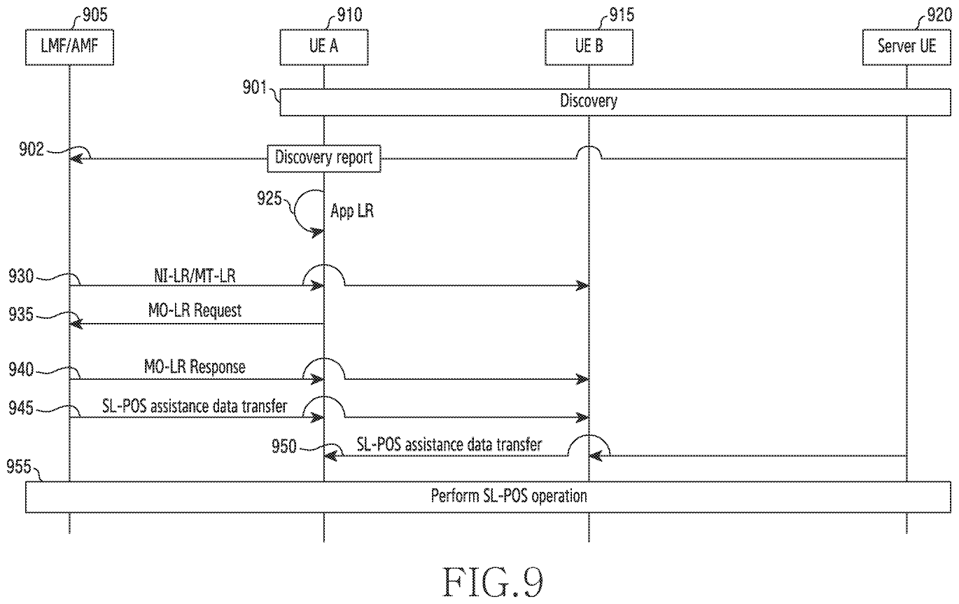

FIG. 9 is a flowchart illustrating a process of selecting a UE for performing an SL-POS operation according to an embodiment of the disclosure.

Referring to FIG. 9, a UE A 910 may discover another UE (e.g., a UE B 915 and/or a server UE 920) within a communication range via discovery 901 (e.g., the procedures of FIGS. 7 and 8), and may transfer the information obtained via the discovery procedure 901 to a ProSe/V2X layer, or an SLPP layer, or an LPP layer.

The SL-POS operation of the UE A 910 may be triggered periodically based on a network setting or based on a setting or request by a main agent of location estimation including an application layer (e.g., an LMF 905, an AMF 905, or a UE that needs to estimate the location of a target UE), or may be triggered when a request for performing an SL-POS operation (e.g., request messages including an application location request 925, a network induced location request 930, a mobile terminated location request 930, and a mobile originated location request 935) is received from an application layer, the LMF 905, the AMF 905, or an LPP layer or SLPP layer of another UE (e.g., the UE B 915 or a server UE 920).

According to an embodiment, in the case in which, when the SL-POS operation of the UE A 910 is triggered, the UE A 910 is not connected to a UE for performing the SL-POS operation (e.g., an anchor UE, a target UE, or a server UE), or the UE A 910 is directed to discover a UE for performing an SL-POS operation, the UE A 910 may perform discovery 901 and may identify whether the UE B 915 or server UE 920 is capable of providing information/function that the UE A 905 prefers or requires, and an identifier of the UE B 915 or server UE 920. The discovery 901 may be, for example, performed periodically before an SL-POS operation is triggered, or after the SL-POS operation is triggered, or by a discovery request from a network entity, and/or an upper layer, and/or another UE.

According to another embodiment, the UE A 910 may provide a report 902 of the whole or a part of the information (e.g., information obtained via the procedures of FIGS. 7 and 8) and the identifier of a neighboring UE (e.g., the UE B 915 or the server UE 920) obtained as a result of the discovery 901 to the LMF 905, the AMF 905, or the server UE 920. The discovery report 902 may be periodically reported, may be reported every time that the discovery 901 is performed, or may be reported when at least one condition is satisfied in the case in which the content of the discovery report 902 is changed. The discovery report 902 may be included in a message in the SL-POS operation, or may be an independent message. Configuration or pre-configuration of a prohibit timer may be performed by a network in order to prevent a report from being frequently provided.

According to yet another embodiment, in the case in which the UE A 910 needs a connection or association with the LMF 905, the AMF 905, or the server UE 920, in order to perform an SL-POS operation, the UE A 910 may preferentially (e.g., the priorities of an IC UE, an LMF, a server UE may be previously configured by a network or may be selected by a UE) select a UE having a connection to the LMF 905 or the AMF 905 (e.g., an IC UE or a UE of which LMF reachability is true), or a UE having a connection to the server UE 920 (e.g., a server UE or a UE of which server UE reachability is true), and may proceed with an SL-POS operation (e.g., connecting a PC5 unicast link, performing SL-POS capability exchange, performing SL-POS assistance data transfer, transmitting an SL-POS-LR, performing measurement via SL-PRS transmission or reception, calculating a measured result, transferring a measurement result to the LMF 905, the AMF 905, or the server UE 920, providing a result to a main agent of location estimation, or the like).

According to still another embodiment, based on the information included in the discovery report 902 reported by the UE A 910, the LMF 905 or the AMF 905 may determine at least one UE that is to perform an SL-POS operation and that satisfies the requirement of a main agent of location estimation. The LMF 905 or AMF 905 may enable the UEs, which are determined to perform the SL-POS operation, to perform SL-POS operation via an NI-LR or MT-LR procedure 930, or a MO-LR response procedure 940, or SL-POS assistance data transfer procedure 945, or the like. The LMF 905 or the AMF 905 may transfer the UE identifier of the at least one UE to perform SL-POS to the UE A 910 and/or UE B 915 via the NI-LR or MT-LR procedure 930, the MO-LR response procedure 940, the SL-POS assistance data transfer procedure 945, or the like, and the UE A 910 and/or the UE B 915 may perform an SL-POS operation with UEs having the identifiers that the LMF 905 or the AMF 905 transfers for performing an SL-POS operation.

Based on the information included in the discovery report 902 reported by the UE A 910, the server UE 920 may determine at least one UE that is to perform an SL-POS operation and that satisfies the requirement of a main agent of location estimation. The server UE 920 may receive an SL-POS location estimation request from the LMF 905, the AMF 905, or another UE (e.g., the UE A 910 and/or UE B 920). The server UE 920 may enable the UEs, determined to perform SL-POS, to perform SL-POS via an SL-POS assistance data transfer procedure 950 or the like. The server UE 920 may transfer the identifier of at least one UE to perform SL-POS to the UE A 910 and/or UE B 915 via the SL-POS assistance data transfer procedure 950 or the like, and the UE A 910 and/or the UE B 915 may perform SL-POS operation with UEs having identifiers that the server UE 920 transfers for performing an SL-POS operation.

By performing an SL-POS operation 955, the UEs that are directed to perform SL-POS may perform measurement for estimating the location of a target UE, may transfer a measurement result value to an entity (e.g., an LMF, AMF, or server UE) that performs calculation or is capable of performing calculation (location calculation) so as to obtain calculated location information, and may estimate the location of the target UE via a procedure such as providing SL-POS location information to a main agent of location estimation (SL-POS provide location information), or the like.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. A plurality of such memories may be included in the electronic device.

Additionally, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first user equipment (UE) in a wireless communication system, the method comprising:
generating a discovery message including information on at least one role of the first UE for a sidelink positioning; and
transmitting, to a second UE associated with the sidelink positioning, the discovery message.

2. The method of claim 1, wherein the discovery message further includes metadata information on a role to be discovered.

3. The method of claim 1,
wherein the first UE is a located UE, and
wherein the discovery message further includes information on a public land mobile network (PLMN) of the first UE.

4. The method of claim 1, wherein the first UE is an anchor UE associated with the sidelink positioning, the second UE is a target UE associated with the sidelink positioning, and the discovery message is a sidelink positioning announcement message.

5. The method of claim 1, wherein the first UE is a target UE associated with the sidelink positioning, the second UE is an anchor UE associated with the sidelink positioning, and the discovery message is a sidelink positioning solicit message.

6. A method performed by a second user equipment (UE) in a wireless communication system, the method comprising:
receiving, from a first UE associated with a sidelink positioning, a discovery message; and
identifying information on at least one role of the first UE for the sidelink positioning based on the discovery message.

7. The method of claim 6, wherein the discovery message further includes metadata information on a role to be discovered.

8. The method of claim 6,
wherein the first UE is a located UE, and
wherein the discovery message further includes information on a public land mobile network (PLMN) of the first UE.

9. The method of claim 6, wherein the first UE is an anchor UE associated with the sidelink positioning, the second UE is a target UE associated with the sidelink positioning, and the discovery message is a sidelink positioning announcement message.

10. The method of claim 6, wherein the first UE is a target UE associated with the sidelink positioning, the second UE is an anchor UE associated with the sidelink positioning, and the discovery message is a sidelink positioning solicit message.

11. A first user equipment (UE) in a wireless communication system, the first UE comprising:
a transceiver; and
a controller coupled with the transceiver and configured to:
generate a discovery message including information on at least one role of the first UE for a sidelink positioning, and
transmit, to a second UE associated with the sidelink positioning, the discovery message.

12. The first UE of claim 11, wherein the discovery message further includes metadata information on a role to be discovered.

13. The first UE of claim 11,
wherein the first UE is a located UE, and
wherein the discovery message further includes information on a public land mobile network (PLMN) of the first UE.

14. The first UE of claim 11, wherein the first UE is an anchor UE associated with the sidelink positioning, the second UE is a target UE associated with the sidelink positioning, and the discovery message is a sidelink positioning announcement message.

15. The first UE of claim 11, wherein the first UE is a target UE associated with the sidelink positioning, the second UE is an anchor UE associated with the sidelink positioning, and the discovery message is a sidelink positioning solicit message.

16. A second user equipment (UE) in a wireless communication system, the second UE comprising:
a transceiver; and
a controller coupled with the transceiver and configured to:
receive, from a first UE associated with a sidelink positioning, a discovery message, and
identify information on at least one role of the first UE for the sidelink positioning based on the discovery message.

17. The second UE of claim 16, wherein the discovery message further includes metadata information on a role to be discovered.

18. The second UE of claim 16,
wherein the first UE is a located UE, and
wherein the discovery message further includes information on a public land mobile network (PLMN) of the first UE.

19. The second UE of claim 16, wherein the first UE is an anchor UE associated with the sidelink positioning, the second UE is a target UE associated with the sidelink positioning, and the discovery message is a sidelink positioning announcement message.

20. The second UE of claim 16, wherein the first UE is a target UE associated with the sidelink positioning, the second UE is an anchor UE associated with the sidelink positioning, and the discovery message is a sidelink positioning solicit message.
